(19) United States
(12) Patent Application Publication
(10) Pub. No.: US 2005/0025859 A1
(43) Pub. Date: Feb. 3, 2005

(54) Process for the production of beer-like carbonated alcoholic beverage

(75) Inventors: Kimihiro Shimamura, Otaru-shi (JP); Tadahiko Hozumi, Shibuya-ku (JP); Takashi Sasaki, Otaru-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HOKKAIDO WINE CO., LTD., OTARU-SHI (JP)

(21) Appl. No.: 10/934,517

(22) Filed: Sep. 7, 2004

Related U.S. Application Data
(63) Continuation of application No. 09/907,658, filed on Jul. 19, 2001, now abandoned.
(63) Continuation of application No. 08/693,227, filed on Aug. 22, 1996, now abandoned.

(51) Int. Cl. C12C 11/00

(52) U.S. Cl. 426/16

(57) ABSTRACT

A beer-like carbonated alcoholic beverage rich ir the characteristic flavor of an organic acid such as malic acid or citric acid is obtained by conducting with a Rhizopus or white-Aspergillus mold the saccharification of malt in beer brewing. The formation of the organic acid during the production process makes it possible to allow the fermentation to proceed stably. Furthermore, the beverage obtained according to the present invention has a high alcohol content and has hence been improved in storage stability. When moto is used as a yeast, a beer-like carbonated alcoholic beverage added with sake flavor can be obtained. When a must of fruit wine is employed, a beer-like carbonated alcoholic beverage added with the flavor of a fruit wine can be obtained.

### TECHNICAL FIELD

The present invention relates to the production of a beer-like carbonated alcoholic beverage which is rich in a flavor of an organic acid such citric acid and malic acid.

### BACKGROUND ART

As a general trend of these days, alcoholic beverages having a high alcohol content and called “hard liquors” are not favored and as typified by the popularity of beer, people incline toward carbonated refreshing alcoholic beverages having a low alcohol content.

In many cases, spirits including vodka and “shochu” (a Japanese low-class distilled spirit) are, after being added with a fruit juice and carbonated water (plain soda), taken as mixed refreshing beverages of a low alcohol content.

The conventional brewing includes the steps of malting, mashing, preparing wort, wort-boiling with hops, removal of the hops, and fermentation. By boiling wort with hops, the wort is imparted with bitterness and aroma, which are characteristic to beer, so that a bittered wort is obtained.

Sake is a typical traditional alcoholic beverage in Japan and its production includes the steps of preparation of koji (the term “koji” means rice with a mold grown thereon and the term “preparation of koji” means to culture Aspergillus oryzae on steamed rice), incubation of a mixture of steamed rice, water and koji in a small scale to obtain a preculture “moto” as a starter or a seed mash, and repeating addition of a mixture of koji, steamed rice and water 3-4 times to the preculture for main fermentation in a large scale. After the main fermentation, the mixture is then pressed and filtered through a press filter. The filtrate is allowed to remain standstill for clarification by precipitation of insoluble materials, and the supernatant is recovered, pasteurized and stored for maturation.

The “moto” is a traditional Japanese word for the preculture as a seed mash in the Sake production process. Among various types of the moto, “kimoto”, “yamahaimoto” and “sokujomoto”, which are also traditional Japanese words, can be exemplified.

The “kimoto is a preculture prepared by a traditional process which includes the steps of
i. preparing in a subdivided form a mixture of steamed rice, water and koji in each of two or eight small and shallow vats having the same volume,
ii. kneading each mixture into a smooth paste, putting the mixtures from the small and shallow vats together into a big vat, and
iii. allowing the mixture to ferment to obtain the kimoto.

The yamahaimoto is prepared by the “yamahai process” as a modified process of the above process for the kimoto. In this modified process, the “yamaoroshi step” consisting of the above steps i and ii is omitted and the mixture of steamed rice, water and koji is directly prepared in a big vat.

In the methods of producing the kimoto and yamahaimoto, wild lactic acid bacteria first grow to reduce pH and then yeasts grow.

The sokujomoto is prepared by the lactic-acid-added quick fermentation process as a modified process of the above yamahai process. In this modified process, lactic acid and an yeast are added to the mixture of steamed rice, water and koji. The mixing of the raw materials is carried out at 18-20° C.

In the process for the production of the preculture moto, rice starch is converted into fermentable sugar by saccharification in the presence of Aspergillus oryzae and the fermentable sugar is converted into ethyl alcohol by a yeast. As the yeast, either natural yeasts (wild yeasts) in atmosphere in which vats are placed or a pure-cultured yeast can be used. In general, natural yeasts which tend to enter the vats from the atmosphere are used in the production of the kimoto and the yamahaimoto, i.e., spontaneous fermentation is often carried out. To facilitate the control of the production process, however, a pure-cultured yeast is also used widely. For the production of the sokujomoto, a pure-cultured yeast is used in general.

### DISCLOSURE OF THE INVENTION

It has been found that beer-like carbonated alcoholic beverages having a flavor characteristic to an organic acid such as malic acid or citric acid can be obtained by applying a modified process of the saccharification step for “sake” at the stage of saccharification in a brewing process, that stable fermentation can be conducted by the production of an organic acid, and also that the quality of the product can be stabilized by raising its alcohol content, leading to the completion of the invention.

An object of the present invention is therefore to provide a process for the production of a beer-like carbonated alcoholic beverage which can fully satisfy the diversified tastes of contemporary consumers.

Another object of the present invention is to provide a process for the production of a beer-like carbonated alcoholic beverage—which has a refreshing taste and also has one of a wide variety of characteristic flavors and is of a low alcoholic content—by adding carbonated water through a dispenser or the like at the final stage of the production or at the final stage that the product is served to consumers.

### BEST MODES FOR CARRYING OUT THE INVENTION

The present invention, therefore, provides a process for the production of a beer-like carbonated alcoholic beverage, which comprises:
(1) a saccharification step in which koji, which has been prepared by a white-Aspergillus or Rhizopus mold, is added to a mixture of water and malt to saccharify the malt; and
(2) a fermentation step in which a yeast is caused to act on sugar, which has been obtained by the saccharification of the malt, for fermentation, thereby obtaining a beer-like carbonated alcoholic beverage.

Various starchy materials can be used as raw materials for the koji used in the step (a). For example, rice, barley and corn are preferred. On one of these starchy materials or a mixture of at least two of them, the white-Aspergillus or Rhizopus mold are cultured to prepare the koji. For the preparation of the koji, any conventional process can be adopted. As the white-Aspergillus or Rhizopus mold, one available publicly or sold commercially can be used.

Examples of usable white-Aspergillus mold include Aspergillus kawachi widely used for the production of “shochu” (low-class distilled spirits), white-koji No. 1-No. 5 which are white Aspergillus for “shochu” and are sold on the market by Akita Konnno Shoten Co., Ltd., as well as other commercially-available white-Aspergillus molds such as “White-Koji Yukikomachi” and “White-Koji Suzuran”.

As molds belonging to the genus Rhizopus, those widely used for the preparation of mochi koji for the use in the production of “samshu” in China and publicly available strains such as Rhizopus oligosporus (ex. NRRL 2710) and Rhizopus oryzae (ex. IFO 5418) can be employed.

The mixing ratio of the koji to the malt is not limited to any particular value. The mixing ratio may be selected, for example, in view of a flavor desired for the final product. For example, when a beer flavor is desired for the final product, the weight ratio of the koji to the malt (koji/malt) may be less than 1/10. When it is desired to make stronger a new flavor other than beer flavor, the weight ratio (koji/malt) may be 1/10 or greater.

In the step (a), one or more additional starchy raw materials may be added to the malt. As such additional starchy raw materials, cereals such as rice, corn, kaoliang and potato; starches; and sugars such as sucrose may be used. The cereals may be used in a ground form. They may be used either singly or in combination. A preferred mixture consists of corn, rice and potato starch at a weight ratio of 1:1:1, and this mixture can be added to dried malt preferably at a ratio of 40-50 g of the mixture to 100 g of the dried malt.

The starchy material can be mixed with the malt before the beginning of the saccharification in which a mixture of the malt and the koji is used. As an alternative, it can be added to the reaction mixture during the saccharification.

When the step (a) and step (b) are carried out separately, the saccharification in the step (a) is generally conducted at 50-80° C. In this case, it is also possible to include, subsequent to the step (a), an additional step in which the saccharified wort, which has been obtained by the saccharification, is boiled with hops to extract bitterness and aroma from the hops into the wort.

No particular limitation is imposed on the amoun of the hops to be added and, the hops can therefore be added for example, in exactly the same amount as a con ventional beer brewing process.

When the step (a) and the step (b) are allowed to proceed simultaneously in the same reaction mixture, concurrent fermentation at lower temperatures is particularly preferred. For the concurrent fermentation, low temperatures of 5-20° C., preferably 5-15° C., more preferably 5-10° C. can be employed. In this case, when bitterness and aroma of hops is desired, an additional step may be included at an appropriate stage to add the bitterness and aroma of hops or to extract them in the reaction mixture.

The alcohol content after the fermentation can be controlled, as needed, by choosing the starchy raw material(s) or subsequent to the addition of bitterness and aroma, adjusting the sugar content of the resultant wort. If the sugar content of the wort is adjusted to attain a final alcohol content of about 8-15 vol. %, a carbonated alcoholic beverage having an alcohol content higher than that of ordinary beer can be obtained.

To achieve such a high alcohol content, it is particularly preferred to control the sugar content of the wort (a mixture of koji, the malt and water, or its saccharified product), in which one or more starchy raw materials may have been added as needed, at a level of 20-25 g in terms of whole sugar per 1 liter of the wort.

Such a high alcohol content can improve the storage stability of the beverage, thereby preventing it from putrefaction. In addition, upon serving it to consumers at a restaurant or the like, its alcohol content can be lowered to a level comparable with that of beer, namely, 4 vol. % or so by diluting it with carbonated water through a dispenser so that a beer-like carbonated alcoholic beverage of refreshing taste and a low alcohol content can be provided. Since the volume of the beverage before the dilution is smaller than that after the dilution, cost saving is feasible on the storage tank and shipping required prior to the dilution.

Examples of the yeast usable in the process (b) include various yeasts for alcoholic fermentation such as those for sake, wine and beer.

When a yeast for sake is used, any of yeast pure cultures available from the Nippon Jozo Kyokai Inc. such as Kyokai Nos. 6, 7, 9-13, 601, 701, 901 and 1001 can be used.

“Moto”, that is, a preculture used as a seed mash in the sake brewing process can also be used. Various motoes such as “kimoto”, “yamahaimoto” and “sokujomoto” which can be prepared by conventional processes can be used. Either spontaneous fermentation or fermentation using a pure yeast culture can be practiced for the production of the moto. As the pure yeast culture, the above-exemplified ones available from the Nippon Jozo Kyokai Inc. and the like can be used.

When moto is used, for example, the moto can preferably be mixed with a mixture of the malt, water and koji or its saccharified product at a ratio of 4-10 liters of the former to 100 liters of the latter.

As the yeast for wine, purely cultured yeasts and those spontaneously grown during wine production can be used. Examples of these yeast pure cultures include Kyokai Nos. 1, 3 and 4 available from the Nippon Jyozo Kyokai Inc.; Catalogue Nos. 12-201, 12-205, 12-207, 12-209, 12-211 and 12-213 available from Cellar Corp. (Seattle, Wash., USA); “SIHA Aktiv Hefe-3” available from E. Begerrow GmbH & Co (Germany); and “U vaferm CM” available form DANSTAR FERMENT AG (Switzerland).

A yeast-containing wine must, which has been obtained in a wine production process, can also be used as it is. Either a spontaneously fermented must or that obtained by using a pure yeast culture can be employed. No particular limitation is imposed on the amount of the wine must to be added. For example, the must can be mixed with a mixture of the malt, water and koji, said mixture containing one or more starchy raw materials as needed, or its saccharified product at a ratio of 5-100 liters of the former to 100 liters of the latter.

Yeast-containing musts, which have been obtained in the production of various fruit wines, can also be used. As the fruit wines, those available from fruit juices containing fermentable sugar, such as apple, peach, pear, persimmon fruit (kaki), strawberry and loquat juices can be used. No particular limitation is imposed on the amount of the wine must to be added. The must, however, can be mixed with a mixture of the malt, water and koji, said mixture containing one or more starchy raw materials as needed, or with its saccharified product at a ratio of 5-100 liters of the former to 100 liters of the latter.

As the yeast for beer, any publicly available or commercially sold beer yeasts can be used.

The alcohol content of the beer-like carbonated alcoholic beverage obtained according to this invention varies depending on the sugar content resulting from the saccharification of the malt, the fermentation period, the maturation period and the like. When a beverage having a high alcohol content, for example, about 8-15 vol. %, which is higher than that of beer, has been obtained but one having a low alcohol content is desired, its alcohol content may be lowered as desired by the addition of carbonated water thereto. The addition of carbonated water can be conducted after the final product is obtained or just before it is supplied to customers. Carbonated water can be added through a dispenser.

According to the process of the present invention, koji prepared using a white-Aspergillus or Rhizopus mold is employed for the saccharification of malt so that a beer-like carbonated alcoholic beverage rich in the flavor of an organic acid such as malic acid or citric acid can be obtained.

A beer-like carbonated alcoholic beverage additionally imparted with the sake flavor can be obtained by using a yeast for sake, particularly moto, as a yeast for fermentation. When a yeast for wine, especially a must from wine production is employed, a beer-like carbonated alcoholic beverage additionally imparted with wine flavor can be obtained. When a yeast-containing must available in the production of fruit wine is used, a fruit-wine flavor can be added to the beer-like carbonated alcoholic beverage.

According to the above-described process of the present invention, beer-like carbonated alcoholic beverages which have at least the flavor of an organic acid such as citric acid or malic acid, said flavor being unfound in any conventional beer, and is also tasteful as a table alcoholic beverage can be obtained by using a white-Aspergillus or Rhizopus mold for the saccharification of wort which may optionally contain one or more starchy raw materials added thereto.

In addition, the production of an organic acid during the saccharification step causes a suitable reduction in pH and the organic acid so obtained favorably acts on the fermentation so that the saccharification and fermentation can be allowed to proceed more stably. As a result, beer-like carbonated alcoholic beverages of stable quality can be produced.

The present invention also makes it possible to attain such a high alcohol content as unavailable in beer brewing, resulting in an improvement in the stability of quality during storage. Furthermore, the product can be supplied easily at a low alcohol content by diluting the product with carbonated water. Since the product has a smaller volume before the dilution than after the dilution, cost saving is feasible on the storage tank and shipping required prior to the dilution.

### EXAMPLE 1

In a room whose temperature and moisture were controllable, a bed was set for preparation of koji.

Rice was steamed and cooled to a temperature between 34 and 36° C. After the room was sterilized, the steamed rice was spread on the bed in the room and agitated to further cool it to a temperature between 30 and 33° C. Then, a commercially sold seed culture of white Aspergillus for the production of koji was mixed at a ratio of 100 g of the seed culture to 100 kg of the steamed rice. The mixture was then treated according to a method publicly known for the production of koji.

First, the mixture was formed into a heap on the bed and covered with a cloth sheet. The temperature of the heap was maintained in the above range and the moisture in the room was controlled to avoid drying of the mixture. About 10 hours later, the heap was leveled down and mixed. Then, the mixture was again formed into a heap and covered with the cloth sheet.

Eleven hours later, the mixture was distributed in small boxes, respectively, and the boxes were stacked one over the other. The boxes were left over, while the temperature of the mixture in each box was controlled between 34° C. and 36° C. by changing the positions of the boxes or mixing again the mixture in the boxes as needed.

Upon an elapsed time of about 43 hours from the distribution of the mixture in the boxes, a rice koji, molding rice, was obtained.

### EXAMPLE 2

The procedure of Example 1 was repeated except for the use of barley, which had been refined and boiled, to prepare a barley koji.

### EXAMPLE 3

The procedure of Example 1 was repeated except for the use of steamed corn to prepare a corn koji.

### EXAMPLE 4

The procedure of Example 1, 2 or 3 was repeated except that a commercially sold mold belonging to the genus Rhizopus was used instead of the white Aspergillus mold to prepare a koji.

### EXAMPLE 5

Steamed rice, water and the rice koji prepared in Example 1 were mixed in small and shallow vats (weight ratio; steamed rice:water:rice koji=96:170 45). The temperature of the mixture was controlled at 8° C. by using cooled water.

The resulting mixture was then treated according to a method publicly known for the production of kimoto.

First, the mixture was allowed to remain standstill for about 10 hours, and was then mixed by oars. The mixture was left over approximately for additional 1.5 days with occasional mixing at an interval of 5-6 hours to mash particles in the mixture to obtain mash. During this step, the temperature of the mixture was controlled below 10° C., preferably at 6-7° C.

The mixture in the mash form was put together into a big vat and further allowed to remain standstill, and then occasionally heated so that the temperature gradually arose to about 15° C. During this step, wild lactic acid bacteria were allowed to grow so that the pH of the mixture dropped. After the heating step, a commercially sold yeast for sake was added to the mixture, and the mixture was then heated occasionally to raise its temperature to 17-19° C. in the course of 1 day to permit growth of the yeast. The temperature of the mixture was then maintained at 20-24° C. for 8-10 hours. Then, the mixture was allowed to remain standstill for 3 days to obtain a kimoto having an acidity of 10.0-11.5 and an alcohol content of 9-11 vol. %. The resulting kimoto was then maintained at 10° C. for 15 days for its use.

### EXAMPLE 6

A mixture of 1 kg of steamed rice, 3 l of water and 1 kg of the rice koji, which had been obtained in Example 1 and dried, was prepared in a big vat. The mixture was then treated according to a method publicly known for the production of yamahaimoto.

First, the mixture was allowed to remain standstill for about 10 hours with occasional mixing by oars. The mixture was then left over for additional 5 days with occasional mixing at an interval of 5-9 hours. During this step, the temperature of the mixture was controlled below 10° C., preferably at 6-7° C.

The mixture was then occasionally heated to gradually raise its temperature to about 15° C. over 6 days. During this step, wild lactic acid-producing bacteria were allowed to grow so that the pH of the mixture dropped. After the heating step, a commercially sold yeast for sake was added to the mixture, and the mixture was then heated occasionally to raise its temperature to 17-19° C. in the course of 1 day to permit growth of the yeast. The temperature of the mixture arose further and remained at 20-24° C. for 8-10 hours. Then, the mixture was allowed to remain standstill for 3 days to obtain a yamahaimoto having an acidity of 10.0-11.5 and an alcohol content of 9-11 vol. %. The resulting yamahaimoto was then maintained at 10° C. for 15 days for its use.

### EXAMPLE 7

The rice koji prepared in Example 1 and water of a temperature between 10 and 12° C. were mixed at a ratio of 35 kg of the rice koji to 115 liters of the cold water. A 75% lactic acid solution (720 ml) and a commercially sold yeast for sake were added further to the mixture to obtain a water-koji mixture. The ratio of the lactic acid solution to the cold water was 800 ml to 1 liter.

Steamed rice and the water-koji mixture were then mixed at a ratio of 35 kg of the rice koji to 70 kg of the steamed rice. The temperature of the mixture thus obtained was controlled to about 20° C. by using hot steamed rice. The mixture was left over and 3 hours later, the mixture was mixed by oars. Then, the mixture was cooled to 10° C. or below, preferably 8° C. in a day. After the cooling, the mixture was then heated occasionally to gradually raise its temperature to 14° C. over 6 days, and then allowed to remain standstill at room temperature for 5 days, during which the temperature of the mixture arose to and remained at about 22° C. by growth of the yeast. The mixture was then cooled gradually to about 8° C. in 2 days and the mixture was then kept at that low temperature for 3 days to obtain a sokujomoto having an acidity of 7-7.5 and an alcohol content of 12 vol. %.

### EXAMPLE 8

Hot water of 80° C. was added to a concentrated wort having a sugar content of 60% to give a total volume of 50 l. To the resulting mixture, a 20% thermally-dissolved sugar solution (containing 20 kg of granulated sugar and 140 g of citric acid) was added, followed by boiling for several minutes. The boiled solution was cooled rapidly to 10° C. through a heat exchanger to obtain 150 l of a wort in which sugar was supplemented. This sugar-supplemented wort was mixed with 2 kg of the barley koji prepared in Example 2 and 3 t of water added thereto. A commercially-available yeast for sake was added to the resulting mixture, followed by fermentation below the maximum temperature of 10° C. for 7 days. After the completion of the fermentation, the mixture so obtained was allowed to remain standstill at a temperature below 10° C. for 2 weeks. Subsequent to the removal of the precipitates and filtration, the filtrate was stored for maturation at 10° C. for a month. Carbonated water was then mixed in the filtrate by a dispenser to give a total volume of 300 l. The beer-like carbonated alcoholic beverage so obtained had a refreshing taste and was characteristically flavored with an organic acid such as citric acid or malic acid.

### EXAMPLE 9

In a manner similar to Example 8 except that one of the motoes which had been prepared in Examples 5-7 was added instead of the commercially-available yeast for sake at a ratio of 1 l of the moto to 20 l of the sugar-supplemented wort, a beer-like carbonated alcoholic beverage rich in the flavor of an organic acid such as citric acid or malic acid was obtained.

### EXAMPLE 10

In a manner similar to Example 8 except that a commercially-available wine yeast was used instead of the commercially-available yeast for sake, a beer-like carbonated alcoholic beverage rich in the flavor of an organic acid such as citric acid or malic acid was obtained.

### EXAMPLE 11

In a manner similar to Example 8 except that a must which had been obtained by fermenting grape juice with a commercially-available wine yeast at 15° C. for a week was added instead of the commercially-available yeast for sake at a ratio of 1 l of the must to 10 l of the sugar-supplemented wort, a beer-like carbonated alcoholic beverage rich in the flavor of an organic acid such as citric acid or malic acid was obtained.

### EXAMPLE 12

In a manner similar to Example 8 except that the koji prepared in Example 4 was used as the koji instead, a beer-like carbonated alcoholic beverage rich in the flavor of an organic acid such as citric acid or malic acid was obtained.

### EXAMPLE 13

Coarsely-ground dry malt (20 kg) was placed in a saccharification tank, followed by the addition of 85 l of warm water of 50° C. and 1 kg of the rice koji which had been prepared using the white-Aspergillus mold in Example 1 and then dried. The resulting mixture was saccharified at 55° C. for 8 hours. The saccharified mixture was thereafter maintained at 70-75° C. for 2 hours, followed by the removal of the spent malt. The resulting wort was added with 250 g of hops, followed by boiling for 15 minutes. While filtering, the boiled mixture was passed through a heat exchanger to cool it to 10° C., whereby a bittered wort having the bitterness and aroma of the hops extracted therein was obtained. “Yamahaimoto” obtained in Example 6 was then added to the bittered wort, followed by fermentation below the maximum must temperature of 15° C. until its alcohol content became 12 vol. %.

The wort so fermented was allowed to remain standstill at a temperature below 10° C. for 2 weeks, followed by the removal of precipitates and filtration. The filtrate was stored for maturation at 10° C. for a month. After the maturation, the matured filtrate was mixed with carbonated water by a dispenser to give a total volume of 300 l, whereby a beer-like carbonated alcoholic beverage added with the flavor of an organic acid such as citric acid or malic acid and also with sake flavor was obtained.

### EXAMPLE 14

In a manner similar to Example 13 except that to the mixture of the dry malt, rice koji and warm water, a 20% starch solution (containing 14 kg of corn starch and 140 g of citric acid) was added further, a beer-like carbonated alcoholic beverage was obtained.

1-7. (canceled)

8. A process for the production of an alcoholic beverage, comprising:
(a) incubating a mixture containing a malt, water, and a koji to saccharify the malt to obtain a wort containing a sugar, wherein said koji comprises a Rhizopus mold cultured on a starchy material selected from the group consisting of rice, barley and corn;
(b) combining said wort with a yeast; and
(c) fermenting said sugar in said wort to obtain an alcoholic beverage.

9. The process of claim 8, wherein said yeast is a sake yeast, a wine yeast, or a beer yeast.

10. The process of claim 8, wherein step (b) comprises the step of adding a preculture moto to said wort,
wherein said preculture moto is a kimoto, a yamahaimoto, or a sokujomoto, and
wherein said preculture moto contains said yeast.

11. The process of claim 8, wherein step (b) comprises the step of adding a wine must to said wort, and
wherein said wine must contains said yeast.

12. The process of claim 8, further comprising, in between step (a) and step (b), the steps of:
(1) boiling said wort with hops, thereby obtaining a bittered wort;
(2) cooling said wort; and
(3) removing solid matter from said wort.

13. The process of claim 8, further comprising, after step (c), the step of adding carbonated water to said alcoholic beverage.

14. A process for the production of an alcoholic beverage, comprising:
incubating a mixture containing a malt, water, a yeast, and a koji,
thereby saccharifying said malt to obtain a sugar, and
thereby fermenting said sugar,
to obtain said alcoholic beverage,
wherein said koji comprises a Rhizopus mold or a white-Aspergillus mold cultured on a starchy material selected from the group consisting of rice, barley and corn, and
wherein said yeast is in the form of a preculture moto or a wine must, and
said preculture moto is a kimoto, a yamahaimoto, or a sokujomoto.—

15. The process of claim 14, wherein said yeast is a sake yeast, a wine yeast, or a beer yeast.

16. The process of claim 14, further comprising adding carbonated water to said alcoholic beverage.

17. The process of claim 8, wherein said starchy material is rice.

18. The process of claim 14, wherein said starchy material is rice.

19. The process of claim 8, wherein said starchy material is barley.

20. The process of claim 14, wherein said starchy material is barley.

21. The process of claim 8, wherein said starchy material is corn.

22. The process of claim 14, wherein said starchy material is corn.—
